(19) United States
(12) Patent Application Publication
(10) Pub. No.: US 2004/0166898 A1
(43) Pub. Date: Aug. 26, 2004

(54) Radio base station apparatus and inter-network interfacing apparatus

(76) Inventor: Yoshiharu Tajima, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/757,642

(22) Filed: Jan. 14, 2004

(30) Foreign Application Priority Data
Feb. 24, 2003 (JP) 2003-045655

(51) Int. Cl. H04M 1/00; H04B 1/38

(52) U.S. Cl. 455/560

(57) ABSTRACT

The present invention relates to a radio base station forming a wireless zone and a network interfacing apparatus mountable on the radio base station. It is an object of the present invention to realize a high-speed, reliable handover without any great change in basic configuration of the radio base station. For this purpose, the radio base station according to the present invention is so configured as to forward a received packet having a transmitting end whose address is not in a predetermined address range, to a radio base station forming a wireless zone adjacent to a wireless zone formed by a local station.

### CROSS REFERENCE TO RELATED APPLICATION

This application is based upon and claims the benefit of priority from Japanese Patent Application No. 2003-045655, filed on Feb. 24, 2003, the entire contents of which are incorporated herein by reference.

### BACKGROUND OF THE INVENTION

1. Field of the Invention

The present invention relates to a radio base station forming a wireless zone and an inter-network interfacing apparatus that can be mounted on the radio base station. Particularly, it relates to a radio base station apparatus which forms a wireless zone adjacent to another wireless zone in a mobile communication system and allocates different IP addresses to a terminal or a call/calls occurring in the terminal in its wireless zone, and it also relates to an inter-network interfacing apparatus that can be mounted on the radio base station.

2. Description of the Related Art

In recent years, data terminals and communication terminals accessible to the Internet have been rapidly coming into widespread use. For radio transmission paths of a next-generation mobile communication system IP addresses have been under active study because of its high affinity to the Internet in place of a multiple access system conforming to circuit switching, and the radio transmission paths and cable transmission sections have become seamless step by step.

FIG. 5 is a view showing a configuration example of a mobile communication system in which different IP addresses are allotted to terminals or calls in a wireless zone.

In the drawing, radio base stations 50-1, 50-2 respectively form wireless zones 61-1, 61-2 having a mutually overlapping area, and a terminal 62 is located in, for example, the wireless zone 61-1 out of these wireless zones 61-1, 61-2. These radio base stations 50-1, 50-2 are connected to a base station controlling station 64 via communication links 63-1, 63-2 respectively.

The radio base station 50-1 includes an antenna 51-1; an antenna duplexer 52-1 connected to a feeding point of the antenna 51-1; a receiving part 53-1 connected to a reception output of the antenna duplexer 52-1; a router 54-1 connected to one end of an interoffice link laid between the router 54-1 and a not-shown exchange office and having an incoming route to which an output of the receiving part 53-1 is connected; a transmitting part 55-1 connected in series to an outgoing route of the router 54-1 and having an output connected to a transmission input of the antenna duplexer 52-1; and a controlling part 56-1 having I/O ports connected to control terminals of the above-mentioned receiving part 53-1, router 54-1, and transmitting part 55-1 respectively, and a communication port connected to one end of the aforesaid communication link 63-1.

Since the configuration of the radio base station 50-2 is the same as the configuration of the radio base station 50-1, common reference numerals with the suffix ‘2’ being appended thereto instead of the suffix ‘1’ are hereinafter used to designate corresponding components, and explanation and illustration thereof will be omitted here.

In the mobile communication system as configured above, the radio base stations 50-1, 50-2 cooperate, via the communication links 63-1, 63-2 respectively, with the base station controlling station 64 that performs call setting in association with the aforesaid exchange office as well as channel control, thereby forming the wireless zones 61-1, 61-2 conforming to predetermined channel allocation and multiple access system.

The radio base station 50-1, recognizing that an occurring call at the terminal 62 has become a successful call in a process of such channel control, allots to the terminal 62 a unique IP address (assumed here to be ‘192.168.0.2’ for simplicity and hereinafter referred to as a first IP address) that has not been allotted to any other terminal or call.

Further, when the terminal 62 retaining such a successful call moves to, for example, the overlapping area of the wireless zones 61-1, 61-2, it outputs a handover request indicating this state to the radio base station 50-1 based on a predetermined channel control procedure (FIG. 6 (a)).

In the radio base station 50-1, the controlling part 56-1 forwards such a handover request, which is received via the antenna 51-1, the antenna duplexer 52-1, and the receiving part 53-1, to the base station controlling station 64 via the communication link 63-1 (FIG. 6 (b)).

In response to the handover request the base station controlling station 64 performs the following processings of:

determining a wireless zone to which the terminal 62 is to be shifted by handover (hereinafter, simply referred to as a moving destination wireless zone, and assumed here to be the wireless zone 61-2 for simplicity);

determining a radio channel that is allottable by the radio base station 50-2 forming the wireless zone 61-2 and has not been allotted to any other terminal or call (hereinafter, referred to as a moving destination radio channel);

outputting a transmission start request, which indicates that the transmission to this moving destination radio channel should be started, to the radio base station 50-2 via the communication link 63-2 (FIG. 6 (c));

outputting to the radio base station 50-1 via the communication link 63-1 a handover request acknowledgement indicating that the terminal 62 should be shifted to such a moving destination radio channel (FIG. 6 (d)).

Note that, in the course of the above-described processings, the base station controlling station 64 may cooperate with the radio base station 50-2 in any form.

In the radio base station 50-1, the controlling part 56-1, recognizing the aforesaid handover request acknowledgement, outputs the handover request acknowledgement to the terminal 62 via the transmitting part 55-1, the antenna duplexer 52-1, and the antenna 51-1 (FIG. 6 (e)).

The terminal 62, recognizing this handover request acknowledgement, performs the following processings:

to appropriately cooperate with the radio base station 50-2 forming the moving destination wireless zone to perform a series of processings including synchronization establishment, a continuity check, and others (hereinafter, simply referred to as radio channel establishment) in the moving destination radio channel (FIG. 6 (f)); and

when the radio channel establishment is normally completed, to output to the radio base station 50-2 a message binding update indicating a request for allotment of a second IP address that corresponds to the moving destination wireless zone and that is to replace the aforesaid first IP address (FIG. 6 (g)).

The radio base station 50-2 forwards such binding update to the base station controlling station 64 via the communication link 63-2.

The base station controlling station 64, when discriminating the binding update, performs the following processings:

to appropriately operate independently or in cooperation with the radio base station 50-2 to secure as the aforesaid second IP address an IP address belonging to a value range that is allowed to be allotted by this radio base station 50-2 and has not been allotted to any other terminal or call (assumed here to be ‘192.168.1.2’ for simplicity) (FIG. 6 (i)). Note that, for simplicity, host addresses of the first IP address and the second IP address are hereinafter assumed to be defined under different subnet masks corresponding to the radio base stations 50-1, 50-2 (the wireless zones 61-1, 61-2) respectively so as to ensure consistency with a known mobile IP which is not always sufficiently adaptable to items unique to mobile communication and radio transmission;

to reflect the relationship between the terminal 62 (or the moving destination radio channel allotted to the terminal 62) and such a second IP address in routing information held by a router 54-2 (FIG. 6 (j)); and

to output a message binding update acknowledgement including this second IP address to the terminal 62 via the communication link 63-2 and the radio base station 50-2 (FIG. 6 (k)).

The terminal 62 applies the second IP address, which corresponds to the IP address allotted in place of the aforesaid first IP address, included in the binding update acknowledgement, as any one of the following addresses (FIG. 6 (m)), thereby completing the handover.

(1) an address of a transmitting end to be disposed on a header of each packet transmitted from the local station

(2) an address to be disposed on a header of a packet whose destination is the local station, out of packets received from the radio base station 50-2 via the moving destination radio channel

Consequently, as long as proper routing information is given to the routers 54-1, 54-2 provided in the radio base stations 50-1, 50-2, and the aforesaid first and second IP addresses conform to this routing information, the handover between overlapping wireless zones 61-1, 61-2, formed by these radio base stations 50-1, 50-2 respectively is achieved with high reliability.

Note that related arts of the present invention or prior arts pertaining to the present invention correspond to, for example, the following documents:

Japanese Unexamined Patent Application Publication No. 2001-189954 (paragraphs 0028, 0031, 0032, and 0076);

Japanese Unexamined Patent Application Publication No. 2001-45534 (paragraphs 0034 to 0037);

Japanese Unexamined Patent Application Publication No. 2002-186006 (paragraph 0054);

Japanese Patent Publication No. 3256498 (claim 1, paragraphs 0002 to 0009, 0019, 0020, and 0027);

Japanese Unexamined Patent Application Publication No. 2002-171572 (paragraphs 0013 and 0014); and

Japanese Patent Publication No. 3321360 (claim 1).

In the above-mentioned conventional example, the handover is not achieved unless the second process (FIG. 6 (g) to (m)) of allotting the second IP address in place of the first IP address is further carried out after the first process (FIG. 6 (a) to (f)) of realizing update of the physical radio channel is completed, and it is highly possible that such a second process may be repeated or partly retried when necessary due to extensive and random fluctuation in characteristics of radio transmission paths formed between the terminal 62 and the radio base stations 50-1, 50-2.

This complicates the procedure of channel control and call setting compared with conventional examples, and adequate service quality has not always been maintained due to the aforesaid repetition or retrial even though transmission performance and speech quality both may possibly been greatly deteriorated in the handover process.

Note that such handover can be achieved also by use of a known cellular IP in place of the aforesaid mobile-IP.

However, it has been difficult to practically apply the cellular IP to a mobile communication system since a range of the size and traffic amount of a wireless zone to which the cellular IP is applicable is small even if routing is realized in a form in which the handover is achievable. Also, the cellular IP is not adaptable to a variety of zone configurations and frequency allocations.

Further, in the radio base station forming the moving destination wireless zone, the routing information to be referred to by the router has to be updated individually for all the terminals or calls which have completed the handover.

However, since a protocol realizing such updating of the routing information has conventionally been planned on the premise that it is applied not to a mobile communication network but to a point to point communication network, it has been difficult for such a protocol by nature to be adaptable to frequent updating of the routing information.

### SUMMARY OF THE INVENTION

It is an object of the present invention to provide a radio base station apparatus and an inter-network interfacing apparatus which realize high-speed, reliable handover without any great change in basic configurations thereof.

It is another object of the present invention to enable the radio base station apparatus and inter-network interfacing apparatus to be adaptable to diversified configurations of communication systems to which the present invention is applied, and to achieve reliable and efficient transmission of various transmission information according not to circuit switching but to store and forward switching or message switching.

It is still another object of the present invention to simplify procedures for handover and others and perform the procedures at a higher speed in accordance with the movement of a transmitting end of a packet, compared with a case when a new address is allotted to the transmitting end along with physical shift in wireless zone or radio channel.

It is yet another object of the present invention to enable the radio base station apparatus and inter-network interfacing apparatus to be adaptable not only to a simplex system but also to both of a half-duplex system and a full-duplex system.

It is yet another object of the present invention to secure a transmission path used for the transmission of a packet without updating of routing information used for routing in accordance with the movement of a transmitting end of the packet.

It is yet another object of the present invention to make it possible to secure a communication channel for transmitting a packet between a transmitting end and a destination of the packet with no routing information for routing executed in a gateway process, even when no address conforming to the routing information is provided to the transmitting end.

It is yet another object of the present invention to secure a communication channel for transmitting a packet between a transmitting end and a destination of the packet with no routing information for routing executed in a gateway process, in a lower-order layer than a layer in which the routing is achieved, even when no address conforming to the routing information is provided to the transmitting end.

It is yet another object of the present invention to decrease to a small value a margin of transmission capacity to be secured for a link formed between wireless zones adjacent to each other.

It is yet another object of the present invention to enable the radio base station apparatus and inter-network interfacing apparatus to be adaptable to the procedures and forms of channel control.

It is yet another object of the present invention to prevent an unnecessary increase in a load of a radio base station in accordance with an increase in a traffic amount of a link or a path used for forwarding a packet having arrived only at a radio base station at which the transmission performance of the packet exceeds a predetermined threshold value.

It is yet another object of the present invention to prevent an unnecessary increase in load of a terminal as a destination of a packet in accordance with an increase in a traffic amount of a radio transmission path used for the radio-transmission of the packet.

It is yet another object of the present invention to properly maintain loads of individual nodes connected to the aforesaid link.

The objects stated above are achieved by a radio base station apparatus which judges a received packet on whether or not an address designating a transmitting end of the packet is in a predetermined range of addresses, and forwards the packet to a radio base station forming a wireless zone adjacent to a wireless zone formed by the local station when a judgment result is false.

Such a radio base station apparatus according to the present invention is able to secure a communication channel to be used for the transmission of the packet without allotting a new address to it, even when the transmitting end of the packet moves from the adjacent wireless zone to the aforesaid wireless zone formed by the local station according to standard procedures for handover and others.

The objects stated above are also achieved by a radio base station apparatus which forwards a packet having arrived from a destination of the aforesaid packet, to the radio base station forming the adjacent wireless zone.

Such a radio base station is able to secure a communication channel for receiving/transmitting transmission information as a sequence of packets between the destination and the aforesaid transmitting end, even after the transmitting end moves from the aforesaid adjacent wireless zone to the wireless zone formed by the radio base station apparatus according to the present invention.

The objects stated above are also achieved by a radio base station apparatus which forwards the packet via a link formed between the radio base station apparatus according to the present invention and the radio base station forming the adjacent wireless zone when the aforesaid judgment result is false.

After the aforesaid transmitting end moves from the aforesaid adjacent wireless zone to the wireless zone formed by the radio base station apparatus according to the present invention, the radio base station apparatus forwards the packet transmitted from the transmitting end to the radio base station forming the adjacent wireless zone in a lower-order layer than a layer in which routing of the packet is executed.

The objects stated above are also achieved by a radio base station apparatus which forwards the packet via a path between the radio base station apparatus and the radio base station forming the adjacent wireless zone when the aforesaid judgment result is false.

After the aforesaid transmitting end moves from the aforesaid adjacent wireless zone to the wireless zone formed by the radio base station apparatus according to the present invention, the radio base station apparatus forwards the packet transmitted from the transmitting end to the radio base station forming the adjacent wireless zone as particular routing in which the path is a known path.

The objects stated above are also achieved by a radio base station apparatus in which the link is formed for each group of radio base stations individually forming adjacent wireless zones.

Such a radio base station apparatus uses only a link formed between wireless zones adjacent to each other for a transmission path used for both or one of a packet with a false judgment result and a packet transmitted from a destination of the packet.

The objects stated above are also achieved by a radio base station apparatus which cooperates with a base station controlling station to determine a path to be used for forwarding a packet having arrived from a destination of the packet, to the radio base station forming the adjacent wireless zone.

Such a radio base station apparatus transmits the packet via a path conforming to channel control executed by the base station controlling station, when the aforesaid judgment result is false.

The objects stated above are also achieved by a radio base station apparatus which cooperates with a base station controlling station to determine a link to be used for forwarding a packet having arrived from a destination of the packet, to the radio base station forming the adjacent wireless zone.

Such a radio base station apparatus transmits the packet transmitted from the destination of the packet by a link conforming to the channel control executed by the base station controlling station, when the aforesaid judgment result is false.

The objects stated above are also achieved by a radio base station apparatus which gleans transmission performance of a packet that arrives at the radio base station forming the adjacent wireless zone from a destination of the packet and forwards the packet only to a radio base station at which the transmission performance exceeds a predetermined threshold value.

Such a radio base station apparatus forwards the packet only to a radio base station that is capable of forming a radio transmission path having a good transmission performance between itself and the destination of the packet.

The objects stated above are also achieved by a radio base station apparatus which determines one of the local station and the radio base station forming the adjacent wireless zone as a specific radio station which is the one receiving the packet latest and/or receiving the packet at a highest level, and judges whether or not the specific radio base station is the local station, to transmit a packet transmitted from a destination of a packet concerned to the radio transmission path when the judgment result is true, and to the specific radio base station when the judgment result is false.

Such a radio base station apparatus forwards the packet only to a radio base station which a transmitting end of the packet substantively visits.

The objects stated above are also achieved by a radio base station apparatus which distributes a packet transmitted from a destination of the packet to the radio base station forming the adjacent wireless zone, and compares the local station to the radio base station forming the adjacent wireless zone to judge whether or not the local station receives a packet latest and/or receives a packet at a highest level, and transmits the packet transmitted from the destination to the radio transmission path only when the judgment result is true.

Such a radio base station apparatus radio-transmits the packet to the destination of the packet only when the packet is forwarded from a radio base station which the transmitting end of the packet substantively visits.

The objects stated above are also achieved by an inter-network interfacing apparatus which physically interfaces with three networks or more in which routing is performed for each packet, and executes routing among the three or more networks as well as forwards to a specific network of the networks a packet having a transmitting end with an address being not in a range of addresses allottable to terminals under the inter-network interfacing apparatus.

Such an inter-network interface apparatus delivers packets with no routing information used for the aforesaid routing to other nodes in sequence via the aforesaid specific network.

The objects stated above are also achieved by an inter-network interfacing apparatus which allowing two networks in which routing is executed for each packet to physically interface with a link which is laid between the inter-network interfacing apparatus and a node, and executes routing between the two networks as well as forwards to the aforesaid link a packet that is provided from one of the networks and has a transmitting end with an address being not in a range of addresses allottable to terminals under the inter-network interfacing apparatus.

Such an inter-network interface apparatus delivers packets with no routing information used for the aforesaid routing to other nodes in sequence via the aforesaid specific link.

The objects stated above are also achieved by an inter-network interfacing apparatus which discriminates a moment synchronizing with a packet having a transmitting end with an address being not in the range of the addresses, and outputs to the link the moment and a signal indicating a sequence of packets forwardable to the link from the aforesaid two networks.

Such an inter-network interfacing apparatus can efficiently and accurately perform processings of acquiring the sequence of packets even when signals received at nodes connected to the link include a signal not indicating the sequence of packets.

### BRIEF DESCRIPTION OF THE DRAWINGS

The nature, principle, and utility of the invention will become more apparent from the following detailed description when read in conjunction with the accompanying drawings in which like parts are designated by identical reference numbers, in which

FIG. 1 is a block diagram showing the principle of a radio base station apparatus according to the present invention;

FIG. 2 is a block diagram showing the principle of an inter-network interfacing apparatus according to the present invention;

FIG. 3 is a diagram showing a first to a fourth embodiment of the present invention;

FIG. 4 is a chart explaining the operation of the first embodiment of the present invention;

FIG. 5 is a chart showing a configuration example of a mobile communication system in which different IP addresses are allotted in a wireless zone; and

FIG. 6 is a chart showing a handover process in a conventional example.

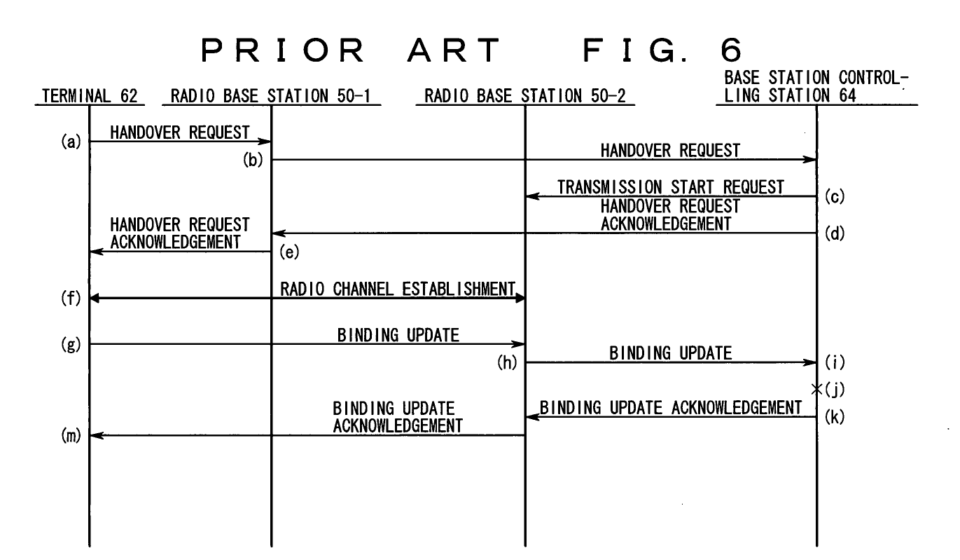

### DESCRIPTION OF THE PREFERRED EMBODIMENTS

First, the principle of a radio base station apparatus and an inter-network interfacing apparatus according to the present invention will be explained.

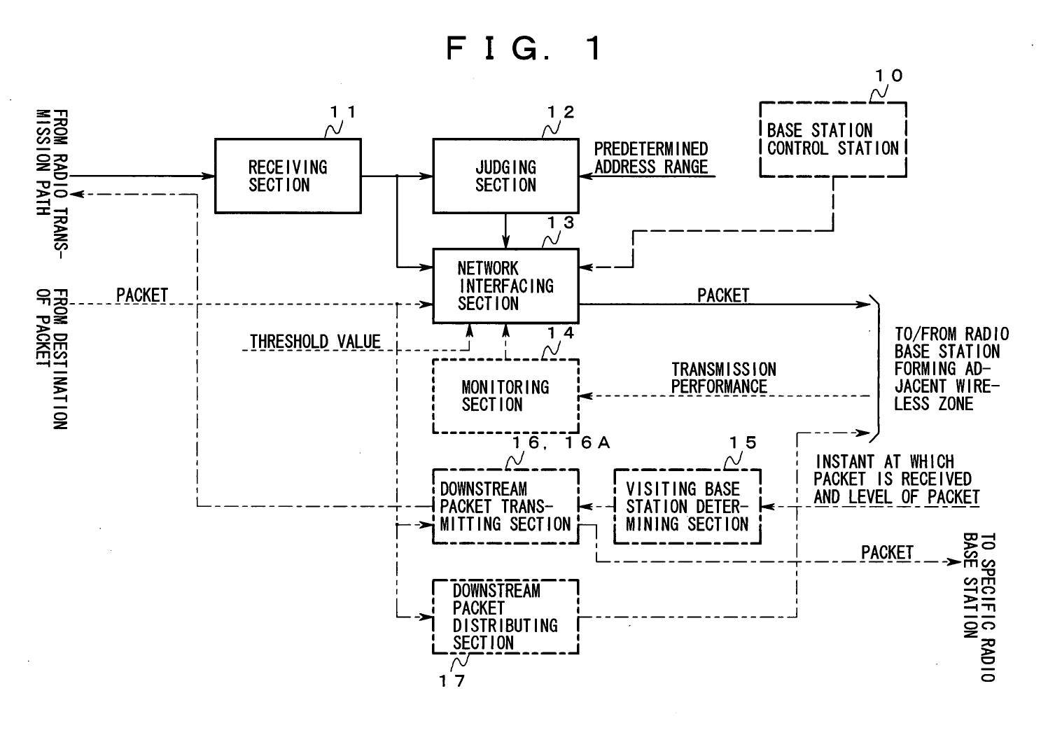

FIG. 1 is a block diagram showing the principle of the radio base station apparatus according to the present invention.

The radio base station apparatus shown in FIG. 1 includes a receiving section 11, a judging section 12, a network interfacing section 13, a monitoring section 14, a visiting base station determining section 15, a downstream packet transmitting section 16 or 16A, and a downstream packet distributing section 17.

In a first radio base station apparatus according to the present invention, the receiving section 11 receives packets via a radio transmission path. The judging section 12 judges the packets on whether or not an address representing a transmitting end of each of the received packets is in a predetermined range of addresses. The network interfacing section 13 routes a packet when a judgment result is true, and forwards a packet to a radio base station forming a wireless zone adjacent to a wireless zone formed by the local station when a judgment result is false.

That is, the radio base station apparatus of the present invention is able to secure a communication channel to be used for the transmission of the packet without allotting a new address to it, even when the transmitting end of the packet moves from the adjacent wireless zone to the aforesaid wireless zone formed by the local station according to standard procedures for handover and others.

Therefore, it is possible to simplify and perform at a higher speed the above-mentioned standard procedures for handover and others in accordance with the movement of the transmitting end, compared with a case when a new address is allotted to the transmitting end whenever the transmitting end of the packet physically moves to one wireless zone or radio channel to another.

In a second radio base station apparatus according to the present invention, the network interfacing section 13 forwards a packet having arrived from a destination of the packet, to the radio base station forming the adjacent wireless zone.

This makes it possible to secure a communication channel for receiving/transmitting transmission information as a sequence of packets between the destination and the aforesaid transmitting end, even after the transmitting end moves from the aforesaid adjacent wireless zone to the wireless zone formed by the radio base station apparatus according to the present invention. This makes the radio base station apparatus adaptable not only to a simplex system but also to both of a half-duplex system and a full-duplex system.

In a third radio base station apparatus according to the present invention, the network interfacing section 13 forwards a packet via a link formed between the radio base station apparatus according to the present invention and the radio base station forming the adjacent wireless zone when a judgment result of the packet is false.

In other words, after the aforesaid transmitting end moves from the aforesaid adjacent wireless zone to the wireless zone formed by the radio base station apparatus according to the present invention, the radio base station apparatus forwards the packet transmitted from the transmitting end to the radio base station forming the adjacent wireless zone in a lower-order layer than a layer in which routing of the packet is executed.

Therefore, a transmission path used for the transmission of the aforesaid packet is secured without updating of routing information used for such routing in accordance with the aforesaid movement of the transmitting end.

In a fourth radio base station apparatus according to the present invention, the network interfacing section 13 forwards a packet via a path between the radio base station apparatus and the radio base station forming the adjacent wireless zone when a judgment result of the packet is false.

After the aforesaid transmitting end moves from the aforesaid adjacent wireless zone to the wireless zone formed by the radio base station apparatus according to the present invention, the radio base station apparatus forwards the packet transmitted from the transmitting end to the radio base station forming the adjacent wireless zone as particular routing in which the path is a known path.

Therefore, a transmission path used for the transmission of the aforesaid packet is secured without updating of routing information used for such routing in accordance with the aforesaid movement of the transmitting end.

In a fifth radio base station apparatus according to the present invention, the link is formed for each group of radio base stations individually forming adjacent wireless zones to each other.

This means that when the aforesaid judgment result of a packet is false, the link formed among the adjacent wireless zones will be a communication path for both or one of the packet and a packet transmitted from the destination of the packet with false result. This makes it possible to decrease to a small value a margin of transmission capacity to be secured for the link formed among the adjacent wireless zones.

In a sixth radio base station apparatus according to the present invention, the network interfacing section 13 cooperates with a base station controlling station that executes channel control relating to the wireless zone formed by the local station and a wireless zone adjacent to the wireless zone, to determine a path to be used for forwarding a packet having arrived from a destination of the packet, to the radio base station forming the adjacent wireless zone.

Therefore, when the aforesaid judgment of a packet is false, the packet is transmitted via a path conforming to the channel control executed by the base station controlling station. This makes the radio base station apparatus of the present invention adaptable to the procedures and forms of channel control.

In a seventh radio base station apparatus according to the present invention, the network interfacing section 13 cooperates with a base station controlling station that executes channel control relating to the wireless zone formed by the local station and its adjacent wireless zone, to determine a link to be used for forwarding a packet having arrived from a destination of the packet, to the radio base station forming the adjacent wireless zone.

In other words, when the aforesaid judgment result of a packet is false, a packet transmitted from the destination of the packet with the false result is transmitted via a link conforming to the channel control executed by the base station controlling station. This makes the radio base station apparatus of the present invention adaptable to the procedures and forms of channel control.

In an eighth radio base station apparatus according to the present invention, the monitoring section 14 gleans transmission performance of a packet that arrives at the radio base station forming each of the adjacent wireless zones from a destination of the packet. The network interfacing section 13 forwards the arriving packet only to a radio base station at which the transmission performance gleaned by the monitoring section 14 exceeds a predetermined threshold value.

This means that such a packet is forwarded only to a radio base station that is capable of forming a radio transmission path having a good transmission performance between itself and the destination of the packet.

This makes it possible to prevent an unnecessary increase in a load of a radio base station which is not the aforesaid radio base station, in accordance with an increase in a traffic amount of a link or a path used for forwarding the packet.

In a ninth radio base station apparatus according to the present invention, the visiting base station determining section 15 determines one of the local station and the radio base station forming the adjacent wireless zone as a specific radio base station which is the one receiving a packet latest and/or receiving a packet at a highest level. The downstream packet transmitting section 16 judges whether or not the specific radio base station is the local station, and transmits a packet transmitted from a destination of the received packet to the radio transmission path when the judgment result is true, and to the specific radio base station when the judgment result is false.

That is, such a packet is forwarded only to a radio base station which a transmitting end of the packet substantively visits. This realizes prevention of an unnecessary increase in load of a radio base station which is not the above-mentioned radio base station, in accordance with an increase in a traffic amount of a link or path used for forwarding the packet.

In a tenth radio base station apparatus according to the present invention, the downstream packet distributing section 17 distributes a packet transmitted from a destination of the packet to the radio base station forming the adjacent wireless zone. The downstream packet transmitting section 16A compares the local station to the radio base station forming the adjacent wireless zone to judge whether or not the local station receives a packet latest at its receiving section 11 and receives a packet at a highest level, and transmits a packet transmitted from the destination of the received packet to the radio transmission path only when the judgment result is true.

This means that such a packet is radio-transmitted to the destination of this packet only when the packet has been forwarded from a radio base station which the transmitting end of the packet substantively visits.

This realizes prevention of an unnecessary increase in load of a terminal as a destination of the packet in accordance with an increase in a traffic amount of a radio transmission path used for the radio-transmission of the packet.

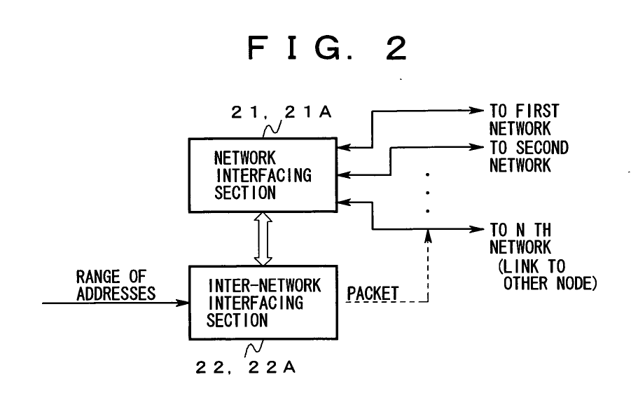

FIG. 2 is a block diagram showing the principle of an inter-network interfacing apparatus according to the present invention.

The inter-network interfacing apparatus shown in the drawing includes a network interfacing section 21 or 21A and an inter-network interfacing section 22 or 22A.

In a first inter-network interfacing apparatus according to the present invention, the network interfacing section 21 allows the inter-network interfacing apparatus to physically interface with three networks or more in which routing is executed for each packet. The inter-network interfacing section 22 executes routing among the three or more networks via the network interfacing section 21 and forwards to a specific network of the three or more networks a packet having a transmitting end whose address is not in a range of addresses allottable to terminals under the inter-network facing apparatus.

Such an inter-network interface apparatus delivers packets with no routing information used for the aforesaid routing to other nodes in sequence via the aforesaid specific network. Therefore, it is possible to secure a communication channel to be used for the transmission of such a packet between a transmitting end and a destination of the packet when no address conforming to the aforesaid routing information is given to the transmitting end.

In a second inter-network interfacing apparatus according to the present invention, the network interfacing section 21A allows two networks in which routing is performed for each packet to physically interface with a link between the inter-network interfacing apparatus and other nodes. The inter-network interfacing section 22A executes routing between the two networks via the network interfacing section 21A, and forwards to the link a packet that is given from one of the networks and whose address of a transmitting end is not in a range of addresses allottable to terminals under the inter-network interfacing apparatus.

In other words, the inter-network interfacing apparatus can deliver a packet with no routing information for routing executed in a gateway process, to other nodes via the aforesaid link.

Therefore, it is possible to secure a communication channel to be used for the transmission of such a packet between a transmitting end and a destination of the packet in a lower-order layer than a layer in which the routing is achieved, even when no address conforming to the routing information is given to the transmitting end.

In a third inter-network interfacing apparatus according to the present invention, the inter-network interfacing section 22A discriminates a moment synchronizing with the packet having a transmitting end whose address is not in the range of the addresses, and outputs to the link the moment and a signal indicating a sequences of packets forwardable to the link from the two networks.

Such an inter-network interfacing apparatus can efficiently and accurately perform processings of acquiring the sequence of packets even when signals received at nodes connected to the link include a signal not indicating the sequence of packets. Therefore, it is possible to maintain loads of individual nodes connected to the aforesaid link properly.

Hereinafter, embodiments of the present invention will be explained in detail based on the drawings.

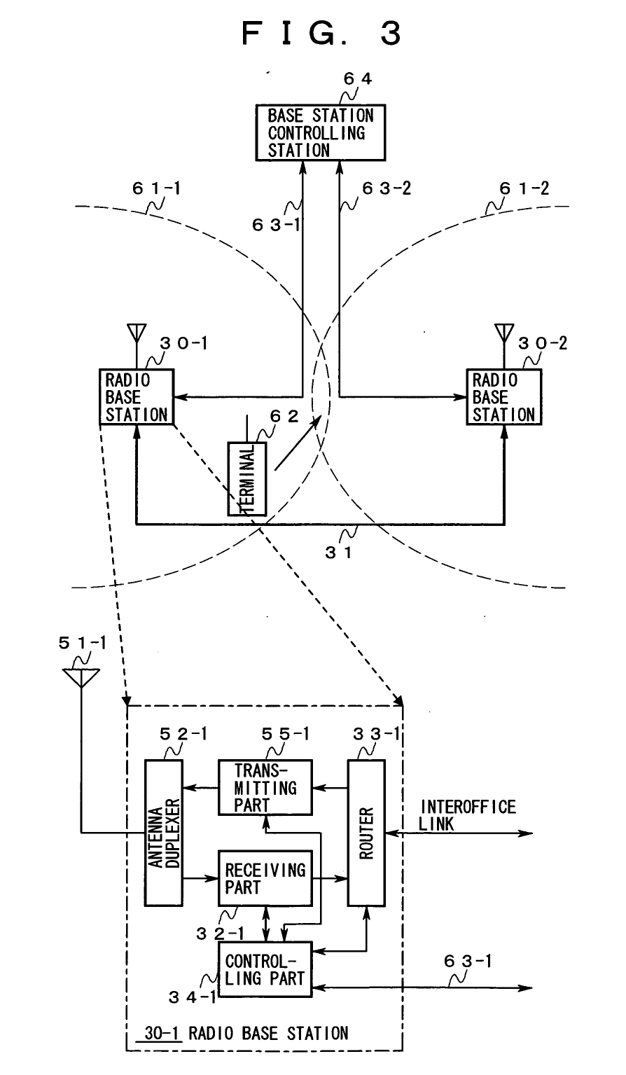

FIG. 3 is a diagram showing a first to a fourth embodiment of the present invention.

In the embodiments shown in FIG. 3, radio base stations 30-1, 30-2 are provided in place of the radio base stations 50-1, 50-2, and an alternative link 31 is laid between these radio base stations 30-1, 30-2.

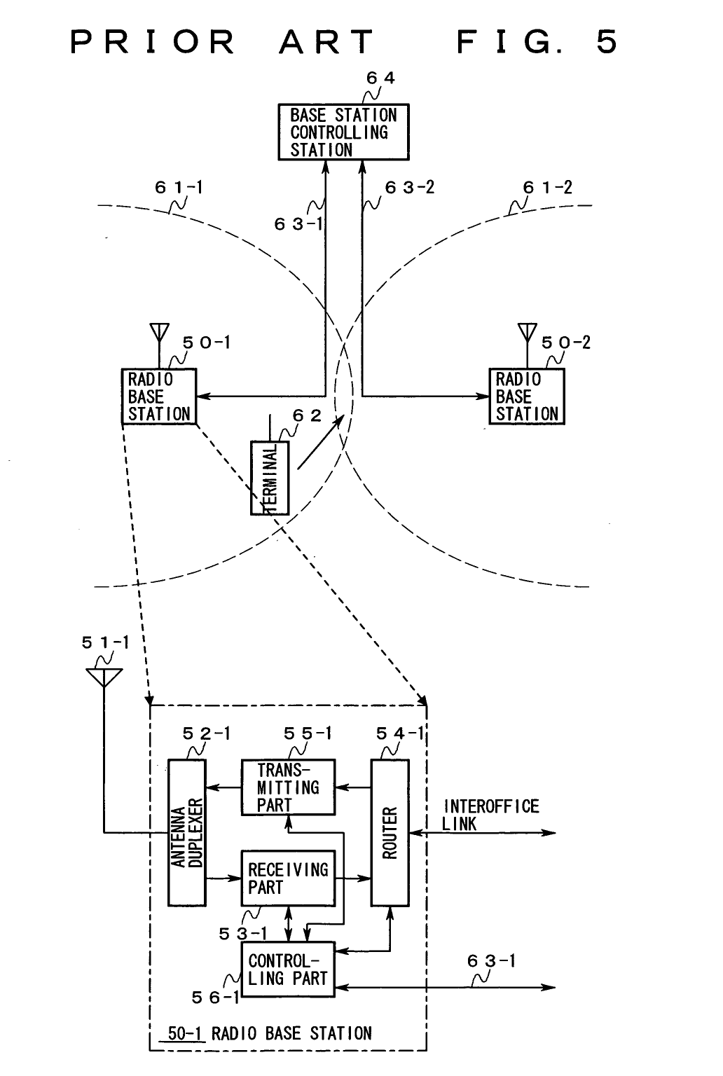

The radio base station 30-1 is configured to have a receiving part 32-1, a router 33-1, and a controlling part 34-1 which replace the receiving part 53-1, the router 54-1, and the controlling part 56-1 shown in FIG. 5 respectively and to be connected to the router 33-1 at one end of the aforesaid alternative link 31.

Since the configuration of the radio base station 30-2 is the same as that of the radio base station 30-1, common reference numerals with a suffix ‘2’ being appended in place of a suffix ‘1’ are hereinafter used to designate corresponding components, and explanation and illustration thereof will be omitted here.

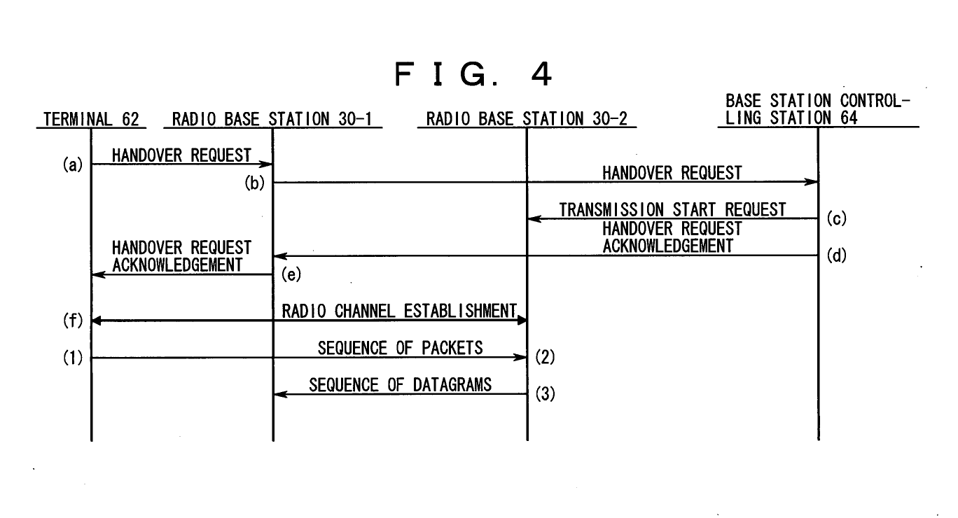

FIG. 4 is a chart explaining the operation of the first embodiment of the present invention.

Hereinafter, the operation of the first embodiment of the present invention will be explained with reference to FIG. 3 and FIG. 4.

This embodiment is characterized in the following process procedure performed by a terminal 62 and the radio base station 30-2 after the aforesaid radio channel establishment is normally completed.

Similarly to the conventional example, the terminal 62 establishes the radio channel in a process of handover from a wireless zone 61-1 to a wireless zone 61-2 (FIG. 4 (f)).

Then, after the radio channel establishment is normally completed, the terminal 62 sequentially transmits packets (each configured to have a first IP address disposed on its header portion as an address of the transmitting end and transmission information disposed on its pay load) whose transmission has been suspended due to this handover, to the radio base station 30-2 via a moving destination radio channel without outputting the aforesaid message binding update to the radio base station 30-2 (FIG. 4 (1)).

Meanwhile, in the radio base station 30-2, a controlling section 34-2 does not reflect the relationship between the terminal 62 (or the moving destination radio channel allotted to the terminal 62) and the aforesaid first IP address in the routing information held by the router 33-2 even when the aforesaid radio channel establishment is normally completed.

The receiving part 32-2 receives the aforesaid packets via the antenna 51-2 and the antenna duplexer 52-2 under the command of the controlling part 34-2 and sequentially gives these packets to the router 33-2 (FIG. 4 (2)).

The router 33-2 takes in the individual packets thus given thereto and tries to route these packets, but such routing cannot be achieved based on the existing routing information.

Nevertheless, the router 33-2 does not discard any of such packets which cannot be routed but sequentially forwards these packets to the radio base station 30-1 (forming the wireless zone of the moving origin) via the alternative link 31 as datagrams conforming to, for example, a CSMA/CD (Carrier Sense Multiple Access with Collision Detection) system (FIG. 4 (3)).

Note that the above datagram is so configured that, for example, in addition to the contents (including all of the header, the pay load, and others) of the corresponding packet, an identifier of the corresponding terminal is disposed on the payload and a unique physical address representing a radio base station being its destination is disposed on the header.

Further, in the radio base station 30-1, the router 33-1 sequentially restores, from these forwarded datagrams, the packets included in the datagrams and routes the packets based on existing routing information.

The controlling part 34-1 appropriately notifies the router 33-1 of the combination of the moving destination wireless zone and the terminal which has normally completed the aforesaid radio channel establishment and moved to the moving destination wireless zone other than the wireless zone 61-1.

As for packets which are given via an interoffice link or the receiving part 32-1 and whose destination corresponds to the terminal 62 located in such a moving destination wireless zone, the router 33-1 sequentially transmits them as datagrams in the same format as that of the aforesaid datagrams to the moving destination wireless zone (assumed here to be the wireless zone 61-2 for simplicity), which is included in the aforesaid combination together with the terminal 62, via the alternative link 31.

In the radio base station 30-2, the controlling part 34-2 appropriately notifies the router 33-2 of the combination of the terminal which has completed the aforesaid radio channel establishment and moved to the wireless zone 61-2 and the moving destination radio channel of this terminal.

The router 33-2, when receiving the aforesaid datagrams via the alternative link 31, restores the packets included in the datagrams.

The router 33-2 further requests a transmitting part 55-2 to transmit the packets to the moving destination radio channel of the terminal represented by the identifier included in each of the datagrams. Specifically, after the terminal 62 has completed the radio channel establishment in the moving destination wireless zone, the routers 30-1, 30-2 can secure a communication channel to be used for the transmission of transmission information such as speech signals and others, via a substitute path which is formed in the alternative link 31 under the above-described process, even when the aforesaid second IP address is not allotted in place of the first IP address which is allotted previously by the radio base station 30-1 in the wireless zone 61-1 being the moving origin.

As described above, according to this embodiment, changing only physical radio channels without changing the IP address makes it possible to realize a high-speed, reliable handover.

Therefore, the handover procedure is shortened and simplified, and transmission performance and service quality are enhanced since the lack of transmission information is prevented.

Note that only wireless zone to which the terminal 62 is movable from the wireless zone 61-1 is the wireless zone 61-2 in this embodiment.

However, the present invention is not limited to such a configuration and similarly applicable to a case when there are a plurality of candidates for the moving destination wireless zone.

Moreover, in this embodiment, the single alternative link 31 is laid between the radio base stations 30-2, 30-1 forming the moving destination wireless zone and the moving origin wireless zone, respectively.

However, the present invention is not limited to such a configuration but, for example, as long as links or paths are formed in parallel between radio base stations forming a desired moving destination wireless zone and moving origin wireless zone respectively, the number of the physical alternative links may be plural and any multiple access system may be applied to these alternative links.

Further, topology of such an alternative link may be any as long as it conforms to the handover achieved by the application of the present invention.

Moreover, in this embodiment, the aforesaid link or path is formed in a data link layer by the application of the above-mentioned CSMA/CD system.

However, such a link or path may be formed in such a manner that, for example, the routers 33-1, 33-2 identify the alternative link 31 as a link similar to the aforesaid interoffice link and perform routing based on routing information that is properly updated based on the handover procedure.

The operation of the second embodiment of the present invention will be explained with reference to FIG. 3.

This embodiment is characterized in the following process procedure performed by the routers 33-1, 33-2 provided in the radio base stations 30-1, 30-2 respectively.

The routers 33-1, 33-2 are given in advance as office data an array of identifiers of radio base stations individually forming other wireless zones adjacent to the wireless zones 61-1, 61-2 respectively (hereinafter, referred to as base station identifiers). Incidentally, such office data may be given by the base station controlling station 64 via the communication links 63-1, 63-2 as information conforming to a predetermined zone configuration.

After the radio channel establishment is normally completed, the router 33-2 in the radio base station 30-2 forming the wireless zone 61-2 being the moving destination wireless zone appends the base station identifier representing the local station (radio base station 30-2) to a datagram to be outputted to the radio base station 30-1 or other radio base station via the alternative link 31.

Meanwhile, when receiving the datagram, the router 33-1 in the radio base station 30-1 performs the following processings:

to extract the base station identifier appended to the datagram;

to judge whether or not this base station identifier is included in the aforesaid array of the base station identifiers; and

to give the same process as that in the above-described first embodiment to the relevant datagram only when the result of the judgment turns out to be true.

In the radio base station 30-1, as for a physical address to be disposed on a header of a datagram (for example, configured to include a packet which is to be transmitted to the terminal 62 located in the moving destination wireless zone via the radio base station forming the moving destination wireless zone) which is to be outputted to other radio base station via the alternative link 31, the router 33-1 limits it only to a physical address of the radio base station represented by the base station identifier included in the aforesaid array of the base station identifiers.

Therefore, even when there exists, in addition to the moving destination wireless zone, a wireless zone which forms in parallel a radio transmission path (including a radio transmission path formed by overreach or the like) between itself and a terminal having completed the handover, the following items are prevented with high reliability:

to apply an unnecessary processing to a datagram which is received by a radio base station whose base station identifier is not included in the aforesaid array of the base station identifiers and which is received via the alternative link 31;

to unnecessarily transmit a datagram to a radio base station whose base station identifier is not included in the aforesaid array of the base station identifiers. Therefore, loads of the controlling parts 34-1, 34-2 and the routers 33-1, 33-2 will be always proper values corresponding to substantive wireless zones, so that overall transmission performance and service quality are stably and highly maintained compared with a case when no restraint is set against the increase in the load.

Hereinafter, the operation of the third embodiment of the present invention will be explained with reference to FIG. 3.

This embodiment is characterized in the following process procedure performed by the routers 33-1, 33-2 and the controlling parts 34-1, 34-2.

The receiving parts 32-1, 32-2 monitor transmission performances (assumed here to be only average values of the level for simplicity) of packets received via individual radio channels, and appropriately give these transmission performances to the routers 33-1, 33-2. The routers 33-1, 33-2 append the corresponding transmission performances to predetermined fields of datagrams including the packets individually received with these transmission performances.

Further, the routers 33-1, 33-2 keep the aforesaid array of the base station identifiers in a permutation satisfying the following two conditions:

to include only the base station identifier representing a radio base station at which the transmission performances extracted from the received individual datagrams exceed a predetermined lower limit value; and

to be configured as an array of the base station identifiers thus extracted and sorted in descending order of the corresponding transmission performances.

In other words, without any change in an IP address allotted to a terminal being made at the handover, a radio base station (including a radio base station forming the moving destination wireless zone) to which a packet whose transmitting end or receiving end corresponds to the terminal is directly forwarded via the alternative link 31 is limited to a radio base station capable of forming a radio transmission path with a good transmission performance between itself and the terminal 62 which has completed the handover.

Therefore, flexible adaptability to a positional movement of a mobile station is realized and not only traffic of the alternative link 31 but also the loads of the routers 33-1, 33-2 and the controlling parts 34-1, 34-2 are kept low, so that transmission quality and service quality are enhanced.

Incidentally, in this embodiment, the aforesaid transmission performance is evaluated as the level as described above.

However, such transmission performance may be substituted by, for example, any of a simple bit error rate, a syndrome calculated in a decoding process conforming to channel decoding applied to the alternative link 31, an average value of deviation in a unit of symbol in a signal space.

The operation of the fourth embodiment of the present invention will be explained with reference to FIG. 3.

This embodiment is characterized in the following process procedure performed by the controlling parts 34-1, 34-2 and the routers 33-1, 33-2.

The receiving parts 32-1, 32-2, similarly to those in the above-described third embodiment, monitor transmission performances (assumed here to be only average values of the level for simplicity) of packets received via individual radio channels, and appropriately give these transmission performances to the routers 33-1, 32.

Further, the routers 33-1, 33-2, similarly to those in the above-described third embodiment, append the corresponding transmission performances to predetermined fields of datagrams including the packets individually received with these transmission performances.

The routers 33-1, 33-2 also determine a single radio base station identifier satisfying the following conditions (hereinafter, referred to as a specific radio base station identifier), from the base station identifiers included in the aforesaid array of the base station identifiers.

(1) to represent a radio base station at which the transmission performance extracted from the received datagram exceeds a predetermined threshold value.

(2) to represent a radio base station which received the datagram at the latest instant.

Further, as for a packet to be transmitted to a terminal which has moved to a wireless zone formed by a radio base station other than the local station, the routers 33-1, 33-2 transmit it as the aforesaid datagram to the radio base station represented by the aforesaid specific radio base station identifier via the alternative link 31.

This means that a packet is transmitted to a terminal which has completed the handover only via a radio base station forming a wireless zone which received, from the terminal at the latest instant, a packet of a transmission performance exceeding the aforesaid threshold value.

Therefore, according to this embodiment, downstream transmission performance in a wireless section is highly maintained compared with a case when such a radio base station is determined with any special selection being made or a plurality of radio base stations are simply set as such a radio base station.

Incidentally, in this embodiment, the aforesaid radio base station is set to a radio base station corresponding to a transmitting end of a datagram (including an upstream packet) that was received at the latest instant as long as the aforesaid transmission performance exceeds the threshold value).

However, in setting such a radio base station, priority may be given to, for example, a radio base station which receives an upstream packet at the highest level as long as the setting conforms to the terminal's movable speed and to the size and other configuration of a wireless zone.

Moreover, in the above-described embodiments, a forward channel for packets among a plurality of adjacent radio base stations is formed in a layer of the alternative link 31 higher than the data link layer.

However, such a forward channel may be formed in a physical layer in the following forms:

to select a channel, out of a plurality of channels formed in the alternative link 31, which is associated with in advance or appropriately allotted to a transmitting end and a receiving end of a packet to be forwarded to other radio base station;

to transmit a signal indicating a frame or other transmission unit including the above packet via thus selected channel;

to separately transmit a synchronization signal, a frame pattern, or other signal indicating that the aforesaid transmission unit is valid via this channel or other channel corresponding to this channel; and

to give a process equivalent to the aforesaid process only to such a valid transmission unit.

Moreover, in the above-described embodiments, no specific description is given on any of the zone configuration, channel allocation, frequency allocation, multiple access system, and modulation scheme applied to the wireless zones 61-1, 61-2.

However, these zone configuration, channel allocation, frequency allocation, multiple access system, and modulation scheme may be any as along as a predetermined radio channel is allotted to a terminal based on the channel control procedure and transmission information is transmitted as a packet sequence in a datagram system via this radio channel.

Further, in the above-described embodiments, any specific description is given neither on the routing form performed by the routers 33-1, 33-2 nor on any of a routing protocol applied to the routing and the contents and format of the routing information.

However, these routing form, routing protocol, and routing information may be any as long as the forward of datagrams or packets via the alternative link 31 between the radio base stations 30-1, 30-2 is realized.

Further, in the above-described embodiments, the router 33-1 (33-2) is so structured that one of the following is merged in a router which is incorporated in the radio base station 30-1 (30-2) and which is connected to the receiving part 32-1 (32-2), the transmitting part 55-1 (55-2), and the interoffice link to perform predetermined routing.

(1) a bridge for exchanging the aforesaid datagram to/from the radio base station 30-2 (30-1) via the alternative link 31

(2) a router to route a packet to be given in place of this datagram

However, both or one of these routers 33-1, 33-2 may be configured as an independent inter-network interfacing apparatus in which a repeater forming the forward channel in the physical layer as described above is integrated in place of the aforesaid bridge.

The invention is not limited to the above embodiments and various modifications may be made without departing from the spirit and scope of the invention. Any improvement may be made in part or all of the components.

What is claimed is:

1. A radio base station apparatus comprising:
a receiving section for receiving a packet via a radio transmission path;
a judging section for judging the packet on whether or not an address designating a transmitting end thereof is in a predetermined range of addresses; and
a network interfacing section for routing the packet when a judgment result is true, and forwarding the packet to a radio base station when the judgment result is false, the radio base station forming a wireless zone adjacent to a wireless zone formed by a local station.

2. The radio base station apparatus according to claim 1, wherein
said network interfacing section forwards a packet which has arrived from a destination of the received packet, to the radio base station forming the adjacent wireless zone.

3. The radio base station apparatus according to claim 1, wherein
said network interfacing section forwards the packet via a link when the judgment result is false, the link being formed between the radio base station apparatus and the radio base station forming the adjacent wireless zone.

4. The radio base station apparatus according to claim 2, wherein
said network interfacing section forwards the packet via a link when the judgment result is false, the link being formed between the radio base station apparatus and the radio base station forming the adjacent wireless zone.

5. The radio base station apparatus according to claim 1, wherein
said network interfacing section forwards the packet via a path when the judgment result is false, the path being formed between the radio base station apparatus and the radio base station forming the adjacent wireless zone.

6. The radio base station apparatus according to claim 2, wherein
said network interfacing section forwards the packet via a path when the judgment result is false, the path being formed between the radio base station apparatus and the radio base station forming the adjacent wireless zone.

7. The radio base station apparatus according to claim 3, wherein
said link is formed for each group of radio base stations individually forming adjacent wireless zones.

8. The radio base station apparatus according to claim 4, wherein
said link is formed for each group of radio base stations individually forming adjacent wireless zones.

9. The radio base station apparatus according to claim 1, wherein
said network interfacing section cooperates with a base station controlling station for executing channel control relating to the wireless zone formed by the local station and to the adjacent wireless zone, to determine a path to be used for forwarding a packet which has arrived from a destination of the received packet, to the radio base station forming the adjacent wireless zone.

10. The radio base station apparatus according to claim 2, wherein
said network interfacing section cooperates with a base station controlling station for executing channel control relating to the wireless zone formed by the local station and its adjacent wireless zone, to determine a path to be used for forwarding a packet which has arrived from a destination of the received packet, to the radio base station forming the adjacent wireless zone.

11. The radio base station apparatus according to claim 5, wherein
said network interfacing section cooperates with a base station controlling station for executing channel control relating to the wireless zone formed by the local station and its adjacent wireless zone, to determine a path to be used for forwarding a packet which has arrived from a destination of the received packet, to the radio base station forming the adjacent wireless zone.

12. The radio base station apparatus according to claim 6, wherein
said network interfacing section cooperates with a base station controlling station for executing channel control relating to the wireless zone formed by the local station and its adjacent wireless zone, to determine a path to be used for forwarding a packet which has arrived from a destination of the received packet, to the radio base station forming the adjacent wireless zone.

13. The radio base station apparatus according to claim 1, wherein
said network interfacing section cooperates with a base station controlling station for executing channel control relating to the wireless zone formed by the local station and its adjacent wireless zone, to determine a link to be used for forwarding a packet which has arrived from a destination of the received packet, to the radio base station forming the adjacent wireless zone.

14. The radio base station apparatus according to claim 1, further comprising
a monitoring section for gleaning transmission performance of a packet that arrives at the radio base station forming the adjacent wireless zone from a destination of the received packet, wherein
said network interfacing section forwards the arriving packet only to a radio base station at which the transmission performance gleaned by said monitoring section exceeds a predetermined threshold value.

15. The radio base station apparatus according to claim 1, further comprising:
a visiting base station determining section for determining one of the local station and the radio base station forming the adjacent wireless zone as a specific radio base station which is the one receiving a packet latest and/or receiving a packet at a highest level; and
a downstream packet transmitting section for judging whether or not the specific radio base station is the local station, and transmitting a packet transmitted from a destination of the received packet to the radio transmission path when the judgment result is true, and to the specific radio base station when the judgment result is false.

16. The radio base station according to claim 1, further comprising:
a downstream packet distributing section for distributing a packet transmitted from a destination of the received packet to the radio base station forming said adjacent wireless zone; and
a downstream packet transmitting section for comparing the local station to the radio base station forming the adjacent wireless zone to judge whether or not the local station receives a packet latest at its receiving section and/or receives a packet at a highest level, and transmitting the packet transmitted from the destination of the received packet to the radio transmission path only when the judgment result is true.

17. An inter-network interfacing apparatus comprising:
a network interfacing section for allowing the inter-network interfacing apparatus to physically interface with three networks or more in which routing is executed for each packet; and
an inter-network interfacing section for executing routing among the three or more networks via said network interfacing section and forwarding to a specific network of the three or more networks a packet having a transmitting end with an address being not in a range of addresses allottable to terminals under the inter-network interfacing apparatus.

18. An inter-network interfacing apparatus comprising:
a network interfacing section for allowing two networks in which routing is executed for each packet to physically interface with a link laid between the inter-network interfacing apparatus and a node; and
an inter-network interfacing section for executing routing between the two networks via said network interfacing section and forwarding a packet to the link, the packet being provided from one of the two networks and having a transmitting end with an address being not in a range of addresses allottable to terminals under the inter-network interfacing apparatus.

19. The inter-network interfacing apparatus according to claim 18, wherein:
said inter-network interfacing section discriminates a moment synchronizing with a packet having a transmitting end with an address being not in the range of addresses; and
said network interfacing section outputs a signal and the moment to the link together, the signal indicating a sequences of packets forwardable from the two networks to the link.
